(19) United States
(12) Patent Application Publication
(10) Pub. No.: US 2026/0050159 A1
(43) Pub. Date: Feb. 19, 2026

(54) Display Device

(71) Applicant: Marelli Corporation, Saitama-city, Saitama (JP)

(72) Inventors: Kodai Nii, Saitama-city, Saitama (JP); Akihiro Eda, Saitama-city, Saitama (JP); Mikio Ishii, Saitama-city, Saitama (JP)

(21) Appl. No.: 19/102,117

(22) PCT Filed: Jul. 14, 2023
(86) PCT No.: PCT/JP2023/026062

§ 371 Date: Feb. 7, 2025

(30) Foreign Application Priority Data
Aug. 10, 2022 (JP) 2022-128481

(51) Int. Cl. G02B 27/01; B60K 35/23; G02B 27/28

(52) U.S. Cl. CPC G02B 27/0101; B60K 35/23; G02B 27/286

(57) ABSTRACT

A display device may include a liquid crystal display and a reflector. The liquid crystal display emits light consisting of P-polarized light. The reflector may be provided between the liquid crystal display and the front windshield. The reflector reflects the emitted light OL from the liquid crystal display toward the driver's eyepoint EP. The reflector has a reflective surface provided with reflection enhancing treatment to reflect P-polarized light. The liquid crystal display may be positioned in a region where the angle of incidence α onto the front windshield of the emitted light OL is 69.7° or less.

### CROSS-REFERENCE TO RELATED APPLICATION(S)

This application is a national stage 371 application of International Patent Application Serial No. PCT/JP2023/026062, filed on Jul. 14, 2023, which claims priority to Japanese Patent Application Serial No. 2022-128481, filed Aug. 10, 2022, the entire disclosure of which is hereby incorporated by reference.

### FIELD

The present invention relates to a display device.

### BACKGROUND

International Publication No. 2020/110580 discloses a display device equipped with a display member that emits light forming an image. The display member is, for example, installed inside the instrument panel of a vehicle. The light emitted from the display member is reflected by a front windshield of the vehicle and directed toward the occupant's eyepoint. This allows the occupant to visually perceive a virtual image of the image generated by the display member.

### SUMMARY

A display device may include a reflector, that is provided separately from the front windshield, that reflects the emitted light from the display member. The reflector may be provided near the front windshield. However, the emitted light of the display member may be reflected not only by the reflector but also by the front windshield. In this case, the occupant may see two virtual images—one from the light reflected by the reflector and another from the light reflected by the front windshield.

One or more aspects of the present invention are directed to a display device that reduces the reflection of the emitted light from the display member by the front windshield.

The display device according to one aspect of the present invention includes a display member that emits light consisting of P-polarized light, and a reflector provided between the display member and a windshield in a longitudinal direction of a vehicle, which reflects an emitted light from the display member toward an eyepoint of an occupant of the vehicle. The reflector has a reflective surface provided with reflection enhancing treatment to reflect P-polarized light, and the display member is positioned in a region where the angle of incidence onto the windshield of the emitted light is 69.7° or less.

According to one or more aspects of the present invention, the display device may reduce the reflection of light emitted from the display member by the front windshield.

### BRIEF DESCRIPTION OF THE DRAWINGS

FIG. 1 is a schematic view showing the configuration of a display device according to an embodiment;

FIG. 2 is a view showing the operation of the display device;

FIG. 3 is a graph showing the relationship between the angle of incidence and the reflectance of S-polarized light and P-polarized light;

FIG. 4 is a view showing a comparative example; and FIG. 5 is a schematic view showing the configuration of a display device according to Modified Example 1.

### DETAILED DESCRIPTION

Hereinafter, the display device according to an embodiment of the present invention will be described with reference to the drawings.

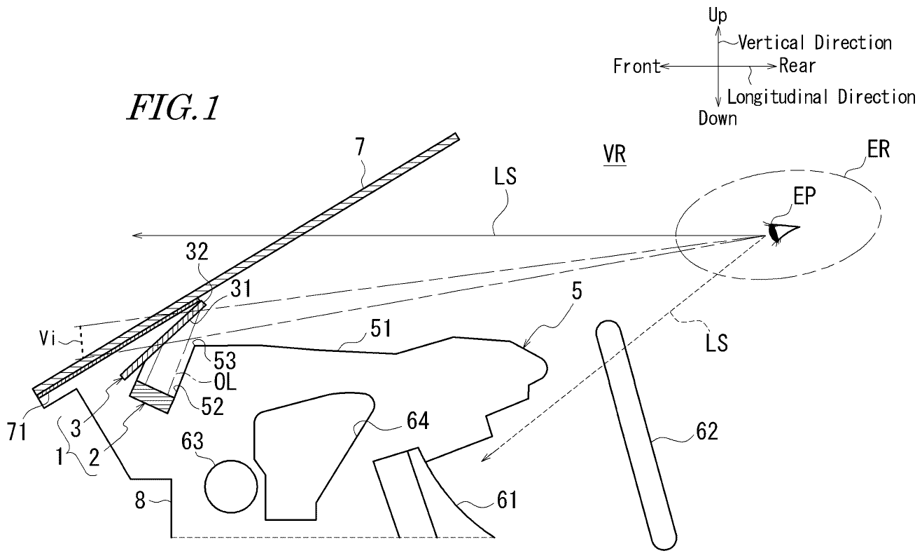

FIG. 1 is a schematic view showing the configuration of a display device 1 according to the embodiment. In FIG. 1, hatching is applied to the display device 1 and the front windshield 7 for clarity.

As shown in FIG. 1, the display device 1 is installed within a vehicle interior VR of a vehicle such as an automobile.

The drawings indicate directions based on the installed state of the display device 1 in the vehicle interior VR. In the following description:

“Up” and “Down” refer to the “upward” and “downward” directions along the vertical line (the vertical direction in FIG. 1).

“Front” and “Rear” refer to the “vehicle front side” and “vehicle rear side” along the vehicle's longitudinal direction of the vehicle (the left-right direction in FIG. 1).

Additionally, the direction perpendicular to both the vehicle's longitudinal direction and the vertical direction is referred to as the vehicle width direction.

As shown in FIG. 1, an instrument panel 5 is provided within the vehicle interior VR. The instrument panel 5 is a covering member that covers the front side of the vehicle interior VR. On the vehicle front side of the instrument panel 5, a dash panel 8 is provided. The dash panel 8 serves as a partition wall that separates the vehicle interior VR from an engine room (or motor room), which is not illustrated.

Above the dash panel 8, a front windshield 7 is installed. The front windshield 7 is inclined and extends diagonally upward from the vehicle front side to the rear side. Specifically, the front windshield 7 protrudes from the upper side of the dash panel 8, crossing over the upper side of the instrument panel 5 in the vehicle's longitudinal direction.

At the lower edge of the front windshield 7, a band-shaped portion 71 is formed where a black ceramic paint is applied in a strip. The band-shaped portion 71 extends upward beyond the upper surface 51 of the instrument panel 5.

In the schematic view of FIG. 1, the band-shaped portion 71 is schematically illustrated on the surface of the front windshield 7. However, the band-shaped portion 71 is not limited to the specific configuration. For example, the band-shaped portion 71 may be formed as an intermediate layer between the glass layers that constitutes the front windshield 7. Alternatively, the band-shaped portion 71 may be formed by painting or the like on the interior-facing surface of the front windshield 7.

A meter 61, which indicates the driving information of the vehicle, is mounted on the instrument panel 5. The meter 61 is installed on the rear-facing side of the instrument panel 5. The meter 61 is located near the steering wheel 62 which is gripped by the driver.

Inside the instrument panel 5, various components are arranged, including a steering member 63, an air-conditioning duct 64, and others.

The steering member 63 extends in the vehicle width direction and is connected to side panels (unillustrated) of the vehicle. The steering member 63 supports the steering wheel 62 through components such as a steering column and steering shaft (unillustrated).

The air-conditioning duct 64 circulates air throughout the vehicle interior with temperature and humidity adjusted by an unillustrated air-conditioning unit.

As shown by the solid arrow in FIG. 1, the driver views the exterior of the vehicle through the front windshield 7 during driving. Therefore, the driver's line of sight LS primarily extends horizontally from the eyepoint EP, with the focus directed toward the front of the vehicle.

On the other hand, the meter 61, installed on the instrument panel 5, is located below the solid line of sight LS and is located on the rear side of the vehicle relative to the instrument panel 5.

As a result, as indicated by the dashed arrow in FIG. 1, the driver must significantly shift their line of sight LS downward and adjust their focus to the rear side of the vehicle (closer to the driver) when checking the information displayed on the meter 61.

The display device 1 in this embodiment is a so-called head-up display device, which is a driver assistance system designed to allow the driver to view vehicle driving information without significantly shifting their line of sight LS or changing the focus position.

The display device 1 can display images as driving information, including, for example, information about the vehicle's status such as driving speed and fuel level, as well as alarms for situations such as pedestrian crossings, vehicle intrusions, or lane crossings.

As shown in FIG. 1, the display device 1 includes a liquid crystal display 2 (display member) that emits light forming an image, and a reflector 3 that reflects the emitted light OL from the liquid crystal display 2 toward the eye range ER.

Specifically, the reflector 3 reflects the emitted light OL from the liquid crystal display 2 and directs the light toward the driver's eyepoint EP located within the eye range ER. The position of the eyepoint EP may vary depending on the driver's physique or posture. The eye range ER is a statistical range within which the driver's eyepoint EP is distributed. That is, the eye range ER shown in FIG. 1 (indicated by a two-dot chain line) is merely a schematic range.

While the surface of the front windshield 7 may also be used to reflect the emitted light OL from the liquid crystal display 2, but in this embodiment, the reflector 3 is provided separately from the front windshield 7.

The liquid crystal display 2 is positioned within a housing section 52 provided inside the instrument panel 5. An opening 53, connecting to the housing section 52, is formed on the upper surface 51 of the instrument panel 5. The opening 53 is positioned along the optical path of the emitted light OL from the liquid crystal display 2.

The liquid crystal display 2 is installed on the front side of components such as the meter 61, the steering member 63, and the air-conditioning duct 64. The liquid crystal display 2 is connected to a display control device (unillustrated), such as an ECU (Electronic Control Unit). The liquid crystal display 2 displays the images input by the display control device.

Although not shown in the drawings, the liquid crystal display 2 includes a liquid crystal cell that is sandwiched between two polarizing plates. The liquid crystal display 2 also includes a backlight that illuminates the liquid crystal cell.

The liquid crystal display 2 can control light passing-through the liquid crystal cell or shut-down therefrom by adjusting the polarization angles of the two polarizing plates. By switching the passing-through or shut-down of for each pixel that forms the image, the liquid crystal display 2 may emit light to create the image.

The backlight emits light containing both P-polarized and S-polarized components; however, one of these polarization components is cut as the light passes through the liquid crystal cell. In other words, the liquid crystal display 2 emits light that contains only one of the two polarization components, either P-polarized or S-polarized light. The liquid crystal display 2 may switch emitting light between P-polarized and S-polarized light by controlling the polarization angles of the two polarizing plates. In this embodiment, the liquid crystal display 2 emits P-polarized light toward the reflector 3.

As shown in FIG. 1, the reflector 3 is installed near the front windshield 7. The reflector 3 is positioned between the instrument panel 5 and the front windshield 7 in the vehicle's longitudinal direction. The reflector 3 is supported by the instrument panel 5, for example, via an unillustrated support member.

The upper edge 32 of the reflector 3 is located, in the vertical direction, at the same level as or slightly above the upper edge of the black band-shaped portion 71 on the front windshield 7. In other words, when viewed from the driver's perspective, at least a part of the reflector 3 overlaps with the black band-shaped portion 71.

As a result, when the driver views the exterior of the vehicle through the front windshield 7, the reflector 3 is less likely to obstruct their field of vision.

The reflector 3 is installed at an incline, sloping diagonally upward from the front side to the rear side of the vehicle. The reflector 3 extends over the top of the opening 53, which is formed on the upper surface 51 of the instrument panel 5. The liquid crystal display 2 is located beneath the opening 53 and housed within the housing section 52.

In other words, in the vertical direction, the reflector 3 is positioned between the front windshield 7 and the liquid crystal display 2. The emitted light OL from the liquid crystal display 2, which is inside the housing section 52 of the instrument panel 5, passes through the opening 53 and reaches the reflector 3.

It should be noted that the position and orientation of the reflector 3 are not limited to the example shown in FIG. 1. These can be appropriately modified based on the layout of the vehicle interior VR and the position of the liquid crystal display 2.

For instance, in the example as shown in FIG. 1, the reflector 3 is positioned diagonally above the liquid crystal display 2. However, the reflector 3 may also be positioned directly above the liquid crystal display 2. Additionally, another reflective component could be installed between the liquid crystal display 2 and the reflector 3. Alternatively, the emitted light OL reflected by the reflector 3 may be further reflected by another reflective component thereafter.

The reflector 3 may compose, for example, an opaque thin plate material. The shape of the reflector 3 is not limited to the specific shape and may be rectangular, polygonal, circular, elliptical, or other shapes.

The reflector 3 has a reflective surface 31 on the side facing the rear of the vehicle. As an example, FIG. 1 shows the reflector 3 having a flat reflective surface. However, the reflector 3 may also be configured with a curved reflective surface. The liquid crystal display 2 can appropriately modify the displayed image according to the shape of the reflector 3 and its reflective surface.

The reflective surface 31, due to the inclination of the reflector 3, faces both the liquid crystal display 2 located below and the driver positioned rear of the vehicle. The reflective surface 31 reflects the emitted light OL of the liquid crystal display 2, which enters from beneath. The reflective surface 31 reflects the emitted light OL toward the driver's eyepoint EP located rear of the vehicle. When the emitted light OL reaches the driver's eyepoint EP, the driver can perceive the virtual image Vi of the image displayed by the liquid crystal display 2.

The reflector 3 is positioned front of and above the meter 61 installed in the instrument panel 5. As a result, compared to viewing the meter 61, the driver can perceive the virtual image Vi formed by the reflector 3 without significantly shifting the line of sight LS or changing their focus position.

The reflective surface 31 is provided with reflection enhancing treatment to increase the reflectance of the emitted light OL consisting of P-polarized light. As an example of reflection enhancing treatment, a surface treatment such as depositing an oxide film on the reflective surface 31 can be applied.

P-polarized light generally tends to have lower reflectance compared to S-polarized light. However, because the reflectance of the reflective surface 31 is increased through the reflection enhancing treatment, the emitted light OL consisting of P-polarized light can be effectively reflected toward the driver's eyepoint EP.

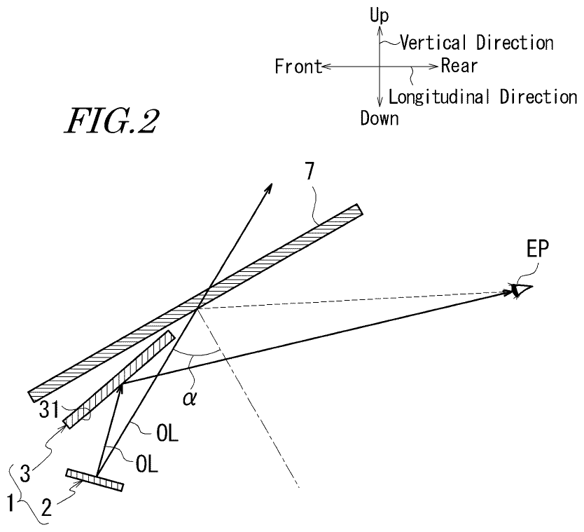

FIG. 2 is a schematic view showing the optical path of the emitted light OL from the liquid crystal display 2.

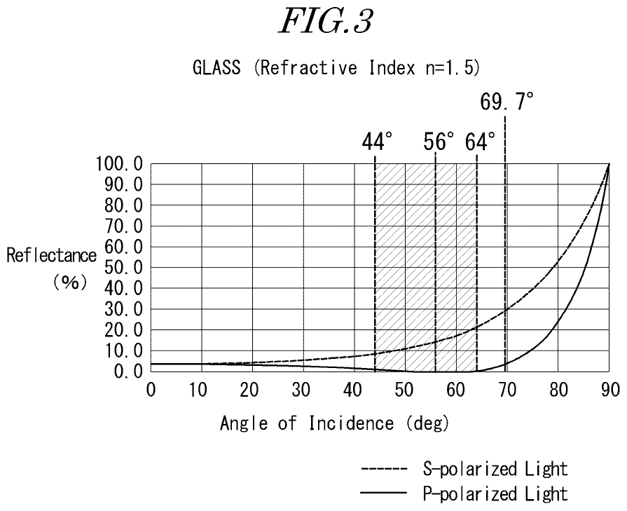

FIG. 3 is a graph illustrating the relationship between the angle of incidence and reflectance for S-polarized and P-polarized light. In FIG. 3, the reflectance of the glass (refractive index n=1.5n) that constitutes the front windshield 7 is shown.

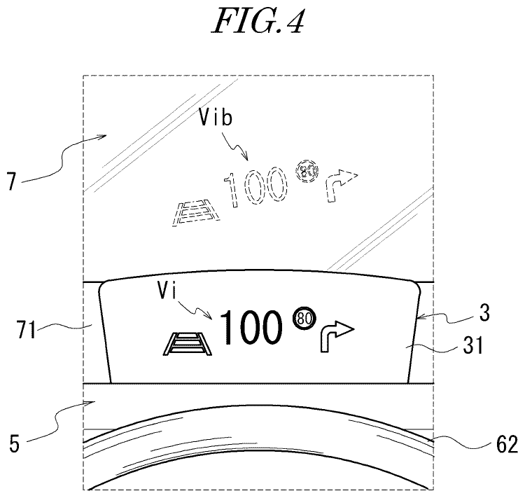

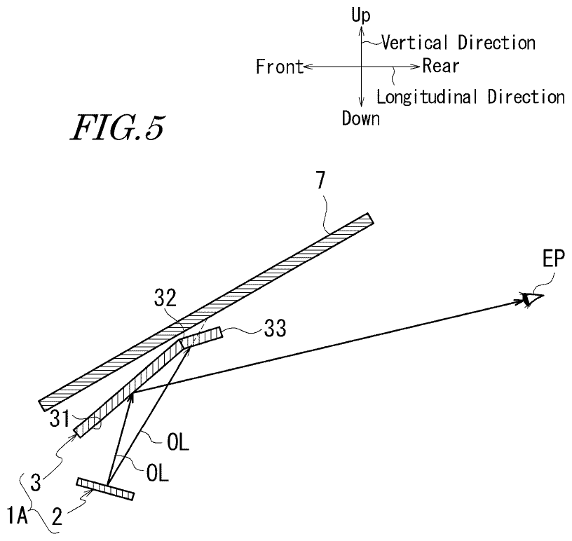

FIG. 4 illustrates a comparative example.

As shown in FIG. 2, the light from the liquid crystal display 2 is emitted toward the reflector 3 positioned above the liquid crystal display 2. As previously mentioned, the reflector 3 is installed between the liquid crystal display 2 and the front windshield 7 in the vertical direction. In other words, the front windshield 7 extends above the reflector 3.

FIG. 1 shows the emitted light OL from the liquid crystal display 2 in a simplified manner; however, in reality, the liquid crystal display 2 emits light radially. As a result, as shown in FIG. 2, the emitted light OL from the liquid crystal display 2 may reach not only the reflector 3 but also the front windshield 7 located above the reflector 3.

FIG. 4 shows the reflector 3 and the front windshield 7 as seen from the driver's perspective. FIG. 4 shows, as a comparative example, the case where the emitted light OL incident on the front windshield 7 is reflected toward the driver's eyepoint EP. In this case, the driver perceives two virtual images: one is the virtual image Vi formed by the reflector 3 and another is the virtual image Vib formed by the front windshield 7.

It would be undesirable for the driver to perceive these two virtual images. Therefore, it would be preferable that the display device 1 reduce the reflectance of the emitted light OL at the front windshield 7.

In this embodiment, the emitted light OL from the liquid crystal display 2 is set as P-polarized light.

As shown in FIG. 3, P-polarized light tends to have a lower reflectance compared to S-polarized light. As mentioned earlier, the reflector 3 is provided with a reflection enhancing treatment so as to effectively reflect P-polarized light.

On the other hand, the front windshield 7 is not provided with a reflection enhancing treatment, therefore P-polarized light is less likely reflected by the front windshield 7.

Furthermore, in this embodiment, the angle of incidence α (see FIG. 2) of the emitted light OL from the liquid crystal display 2 onto the front windshield 7, which is P-polarized light, is set within a range based on the Brewster angle. This may further reduce the reflectance.

The angle of incidence α of the emitted light OL onto the front windshield 7 can be adjusted by modifying the region where the liquid crystal display 2 is positioned. Specifically, for example, the angle a can be appropriately set by adjusting the position of the liquid crystal display 2 in the vehicle's longitudinal direction relative to the front windshield 7.

The Brewster angle is the angle of incidence where the reflectance of P-polarized light becomes zero at the interface of various materials having refractive index different from each other.

As shown in FIG. 3, the Brewster angle for the glass (refractive index n=1.5) that constitutes the front windshield 7 is 56°. The reflectance of P-polarized light may be low near the Brewster angle.

In particular, when the angle of incidence is in the range of 44° to 64°, the reflectance is kept at 1.0% or less. At an angle of incidence of 69.7°, the reflectance is 4%, and when the angle exceeds 69.7°, the reflectance of P-polarized light increases sharply.

In this embodiment, the liquid crystal display 2 is positioned such that the angle of incidence α of the emitted light OL onto the front windshield 7 is, for example, 69.7° or less. More preferably, the liquid crystal display 2 is placed in a region where the angle of incidence α falls within the range of 44° to 64° (see the hatched area in FIG. 3).

As a result, as shown in FIG. 2, even if the emitted light OL from the liquid crystal display 2 enters the front windshield 7, the light OL is more likely to pass through the front windshield 7.

This reduces the case that the virtual image Vib caused by reflections from the front windshield 7 (see FIG. 4) is perceived by the driver.

The angle of incidence α onto the front windshield 7 may be decreased by shifting the region where the liquid crystal display 2 is positioned toward the rear of the vehicle.

However, since the interior of the instrument panel 5 contains many components, such as the steering member 63 and air-conditioning duct 64. The liquid crystal display 2 may interfere with these components when shifting the positioning region of the display 2 toward the rear of the vehicle.

The region where the liquid crystal display 2 is positioned should be determined while also considering the layout of such other components.

As described above, the display device 1 in this embodiment may have the following configuration, for example:
(1) The display device 1 includes a liquid crystal display 2 (display member) and a reflector 3.

The liquid crystal display 2 emits light consisting of P-polarized light.

The reflector 3 is provided between the liquid crystal display 2 and the front windshield 7 (windshield) of the vehicle.

The reflector 3 reflects the emitted light OL from the liquid crystal display 2 toward an eyepoint EP of the driver (occupant).

The reflector 3 has a reflective surface 31 provided with a reflection enhancing treatment to reflect P-polarized light.

The liquid crystal display 2 is positioned in a region where the angle of incidence α onto the front windshield 7 of the emitted light OL is 69.7° or less.

The display device 1 configured as described above may reduce the reflection of the emitted light OL of the liquid crystal display 2 by the front windshield 7.

The reflector 3 may be provided between the liquid crystal display 2 and the front windshield 7 in the vertical direction as shown in the above embodiment. In this case, there is a possibility that the emitted light OL from the liquid crystal display 2 toward the reflector 3 may partially enter the front windshield 7 located above the reflector 3.

If the emitted light OL that enters the front windshield 7 is reflected toward the driver, the driver may perceive not only the virtual image Vi formed by the reflector 3 but also the virtual image Vib formed by the front windshield 7.

It should be noted that the phrase “the reflector 3 is provided between the liquid crystal display 2 and the vehicle's front windshield 7” includes a case where the reflector 3 is positioned between the liquid crystal display 2 and the front windshield 7 in the vehicle's longitudinal direction.

In this embodiment, the emitted light OL from the liquid crystal display 2 is set as P-polarized light, and the liquid crystal display 2 is positioned in a region where the angle of incidence α onto the front windshield 7 of the emitted light OL is 69.7° or less.

P-polarized light generally has a lower reflectance compared to S-polarized light, and particularly, the reflectance of P-polarized light is made lower as nearer to the Brewster angle (56°).

In other words, the angle of incidence α onto the front windshield 7 of the emitted light OL from the liquid crystal display 2 is set to 69.7° or less, which is near the Brewster angle. This reduces the reflection of the P-polarized emitted light OL from the liquid crystal display 2 by the front windshield 7.

As a result, it becomes possible to reduce the likelihood of the virtual image Vib, caused by reflections from the front windshield 7, being perceived by the occupant, as shown in the comparative example in FIG. 4.

On the other hand, the reflective surface 31 of the reflector 3 is provided with reflection enhancing treatment, and thus may effectively reflect the P-polarized emitted light OL toward the driver's eyepoint EP. Consequently, the driver can perceive the virtual image Vi formed by the reflection from the reflector 3.

It should be noted that drivers may wear sunglasses while driving, and most sunglasses are designed to block S-polarized light. By setting the emitted light OL from the liquid crystal display 2 as P-polarized light, the driver can still perceive the virtual image Vi formed by the reflection from the reflector 3, even while wearing sunglasses during driving.

The previously described embodiment shows an example that the display member is a liquid crystal display 2, though the display member is not limited to this example. For instance, an organic EL (Electro Luminescence) display can be used as the display member. The organic EL display may omit the backlight and polarizing plates, allowing the display member to be made thinner.

When using a display member which does not switch between P-polarized and S-polarized light for emission like the liquid crystal display 2, a separate polarizing filter can be installed to cut the S-polarized light from the emitted light OL of the display member. The polarizing filter can be placed, for example, along the optical path of the emitted light OL within the housing section 52.
(2) The liquid crystal display 2 is positioned in a region where the angle of incidence α onto the front windshield 7 of the emitted light OL is 44° or more and 64° or less.

When the angle of incidence α is between 44° and 64°, the reflectance on the front windshield 7 is suppressed to 1.0% or less. This further reduces the reflectance by the front windshield 7 of the emitted light OL from the liquid crystal display 2.
(3) The display device 1 is positioned in front of the meter 61 that displays driving information of the vehicle.

Specifically, the reflector 3, which is included in the display device 1, is positioned in front of the meter 61 in the vehicle's longitudinal direction. Additionally, the reflector 3 is placed above the meter 61.

According to this arrangement, the driver, who primarily directs their line of sight LS horizontally toward the front of the vehicle while driving, may perceive the virtual image Vi formed by the reflector 3 without significantly shifting their line of sight LS or changing their focus position.

Furthermore, the liquid crystal display 2, which is included in the display device 1, is positioned in front of the meter 61 inside the instrument panel 5.

Although the instrument panel 5 contains various components, such as the steering member 63 and air-conditioning duct 64, the liquid crystal display 2 may be placed while minimizing interference with these components.

### Modified Example 1

FIG. 5 is a schematic view showing the configuration of a display device 1A according to Modified Example 1.

As shown in FIG. 5, in Modified Example 1, a visor member 33 (light-shielding member) is provided at the upper edge 32 of the reflector 3. The visor member 33 is connected to the upper edge 32 of the reflector 3 and extends diagonally upward toward the rear of the vehicle. The visor member 33 extends along the inclination of the front windshield 7.

In other words, in the vertical direction, the visor member 33 is positioned between the liquid crystal display 2 and the front windshield 7.

The visor member 33, like the reflector 3, is made of an opaque material but is not provided with a reflection enhancing treatment, unlike the reflective surface 31.

By providing such a visor member 33, at least a part of the light emitted from the liquid crystal display 2 and directed toward the front windshield 7 is blocked by the visor member 33. This reduces the incidence of the emitted light OL from the liquid crystal display 2 onto the front windshield 7. The reflections of the emitted light OL by the front windshield 7 may further be reduced.

Additionally, by aligning the visor member 33 with the inclination of the front windshield 7, the visor member 33 is less likely to obstruct the optical path of the emitted light OL reflected by the reflector 3 toward the eyepoint EP of the driver.

As described above, the display device 1A in the Modified Example 1 may have the following configuration:

1(4) The display device 1A includes a visor member 33 (light-shielding member) that blocks at least a part of the light emitted from the liquid crystal display 2 toward the windshield.

This reduces the incidence of the emitted light OL from the liquid crystal display 2 onto the front windshield 7, thereby further reducing reflections of the emitted light OL on the front windshield 7.
(5) The visor member 33 is positioned at the upper edge 32 of the reflector 3.

Since the front windshield 7 extends above the upper edge 32 of the reflector 3, installing the visor member 33 at the upper edge 32 of the reflector 3 effectively blocks the light emitted from the liquid crystal display 2 toward the front windshield 7.

Modified Example 1 explains the visor member attached to the reflector 3 as an example of the light-shielding member. However, the light-shielding member is not limited to this example. For instance, the visor member may be installed on the upper surface 51 of the instrument panel 5. The visor member can be formed, for example, by raising a part of the upper surface 51 of the instrument panel 5, or by attaching a separate component to the upper surface 51.

### EXPLANATION OF REFERENCE NUMERALS

1: Display device
2: Liquid crystal display
3: Reflector
31: Reflective surface
32: Upper edge
33: Visor member
5: Instrument panel
51: Upper surface
52: Housing section
53: Opening
61: Meter
62: Steering wheel
63: Steering member
64: Air-conditioning duct
7: Front windshield
71: Band-shaped section
8: Dash panel
VR: Vehicle interior
EP: Eyepoint
OL: Emitted light
OP: Optical path
Vi: Virtual image
LS: Line of sight

1. A display device comprising:
a display member that emits light consisting of P-polarized light; and
a reflector provided between the display member and a windshield in a longitudinal direction of a vehicle, which reflects an emitted light from the display member toward an eyepoint of an occupant of the vehicle,
wherein the reflector has a reflective surface provided with a reflection enhancing treatment to reflect P-polarized light, and
the display member is positioned in a region where an angle of incidence onto the windshield of the emitted light is 69.7° or less.

2. The display device according to claim 1, wherein the display member is positioned in a region where the angle of incidence onto the windshield of the emitted light is between 44° and 64°.

3. The display device according to claim 1, further comprising a light-shielding member that blocks at least a part of the emitted light of the display member toward the windshield.

4. The display device according to claim 3, wherein the light-shielding member is provided at an upper edge of the reflector.

5. The display device according to claim 1, wherein the display device is positioned in front of a meter that displays driving information of the vehicle.

6. The display device according to claim 2, wherein the display device is positioned in front of a meter that displays driving information of the vehicle.

7. The display device according to claim 3, wherein the display device is positioned in front of a meter that displays driving information of the vehicle.
